(19) United States
(12) Patent Application Publication
(10) Pub. No.: US 2004/0205991 A1
(43) Pub. Date: Oct. 21, 2004

(54) Display stand for material that is essentially panel-shaped

(76) Inventor: Karl Jarosch, Munich (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/808,599

(22) Filed: Mar. 25, 2004

(30) Foreign Application Priority Data
Mar. 27, 2003 (DE) 103 13 906.0
Feb. 3, 2004 (DE) 10 2004 005 256.5

(51) Int. Cl. G09F 7/00

(52) U.S. Cl. 40/492

(57) ABSTRACT

Display unit for essentially panel-shaped material, consisting of two disk-shaped carrier plates that are spaced apart by a vertically-aligned carrier and each of which is connected to same, and mounting devices for holding the panel-shaped material between the carrier plates, characterized in that, the bottom carrier plate has a larger diameter than the top carrier plate and an equal number of holes, aligned vertically relative to each other, are provided in the top and bottom carrier plates that, with pegs or similar elements that are, or can be, allocated to the particular panel-shaped material, can be brought into reversing, swiveling engagement.

The invention relates to a display stand for material that is essentially panel-shaped.

The presentation of panel-shaped material objects is often difficult because frequently there is too little space for permanent mounting on walls or similar supports in order to be able to provide a wide range and spectrum of display surfaces. Also it is often desirable for the display to be mobile.

In the context of this invention, “panel-shaped materials” or “display surfaces” means mainly samples of floor coverings, particularly those of dimensions that enable viewers to obtain a good overall impression.

Up to now samples could only be made available in small areas as display material.

The object of this invention is therefore to provide the possibility of displaying, particularly samples of floor coverings, in the greatest possible variety and over the largest possible area in the smallest possible space.

The object of the invention is to that extent a display unit for material that is essentially panel-shaped, consisting of two disk-shaped carrier plates spaced apart by a vertical support and joint to it and with mounting devices for holding the panel-shaped material between the carrier plates, characterized in that the bottom carrier plate has a greater diameter than the top carrier plate and that an equal number of holes, aligned vertically relative to each other, is provided in the top and bottom carrier plates that, with pegs or similar elements that are, or can be, allocated to the particular panel-shaped material, can be brought into a reversing and swiveling engagement.

This enables panel-shaped materials, particularly samples of floor coverings that can have a high total weight, to be simply arranged and demonstrated in the smallest possible space. In particular, the different size of carrier plates enables the panel-shaped material to be better introduced.

The disk-shaped design of the carrier plates enables the arrangement of a number of mounting devices, spaced equally apart in the outer circumference of the carrier plates. The swiveling capacity also enables the viewer to easily bring the panel-shaped material to a good position for viewing, and furthermore, this arrangement also enables two different sample surfaces to be provided on one panel-shaped material by forming a front and back side. This form of construction also enables the display unit to be of a practical folding design that thus requires little space.

Also with this form of embodiment, a maximum number of these panel-shaped materials can be arranged between the carrier plates provided the panels themselves are not thicker than the spaces between the mounting devices. The panel-shaped material also offers two display surfaces, on the front and back sides, thus enabling several sample units to be displayed at the same time.

The design of the mounting devices as holes and pegs that engage with each other guarantees a simple handling of the display material and a low manufacturing cost.

To further improve the swiveling of the panel-shaped material, spacers are allocated at least to the pegs that engage with the holes in the bottom carrier plate. These can be welded spacer washers, sleeves or similar.

The display units are further characterized in an advantageous manner in that the holes engage with the pegs or similar elements by means of a snap-on, clamping or similar connection.

This form of embodiment enables the panel-shaped display object to be easily mounted in the carrier unit. In a modified form of this embodiment the holes can also be allocated to the panel-shaped material and the pegs allocated to the carrier plates in an otherwise similar form of embodiment or arrangement.

Advantageously, the pegs or similar elements allocated to the panel-shaped material are part of a frame in which the panel-shaped material itself can be reversibly arranged.

In this way, a change of samples, e.g. in line with seasonal changes or trends, is easily accomplished with the existing display unit.

In a further advantageous form of embodiment, a carrier is formed as a tube, enabling a cable to be routed for illumination of the display stand.

In a further preferred form of embodiment of the invention, the bottom carrier plate of the display unit is provided with rollers that enable the display unit to be moved and thus makes it mobile. The presentation unit can therefore be used for display of samples both within a shop or outside a shop as required. When folded, it can be moved through the shop door at any time.

In as further advantageous embodiment of the object in accordance with the invention, the carrier is longer than the maximum clearance provided between the carrier plates, so that it passes through the center of the top carrier plate and project beyond it. The section of the carrier projecting beyond the top carrier plate can be provided with other devices to take advertising elements or similar. If the carrier is of hollow construction, this feature can also be used to support an advertising shade or sunshade that protects the samples from the weather.

On the base of the top carrier plate and on the carrier, devices, such as hooks, pins or similar, can be provided for supporting or holding display objects. These hooks or pins can, for example, be used to hold skirting strips or profiled samples, preferably on the top carrier plate, or to hold skirting strips on the carrier.

The top of the carrier plate is painted in different colors, star-shaped (radially) as required and/or marked with numbers and/or letters, with this identification being repeated on the top edge of the frame for holding the panel-shaped material. A simple visual allocation to specific quality or price categories is simply achieved in this way. In a best case, this type of marking or allocation is continued in the brochures or price lists.

To summarize, the greatest possible area of surface display in the least space combined with a smooth sales discussion with the customer is thus possible without the need for an interruption to search for supplementary accessories or informative material.

The display unit is, as stated, designed essentially for the display of samples of floor coverings of all kinds. This also opens up the possibility of removing a mounting board from the display unit and, for example, laying it on the floor locally as a sample for the customer.

Naturally, the display unit is not limited to this application, it also allows other large-area samples such as wall paneling, cladding, wallpaper sheets, mirror surfaces or similar to be displayed.

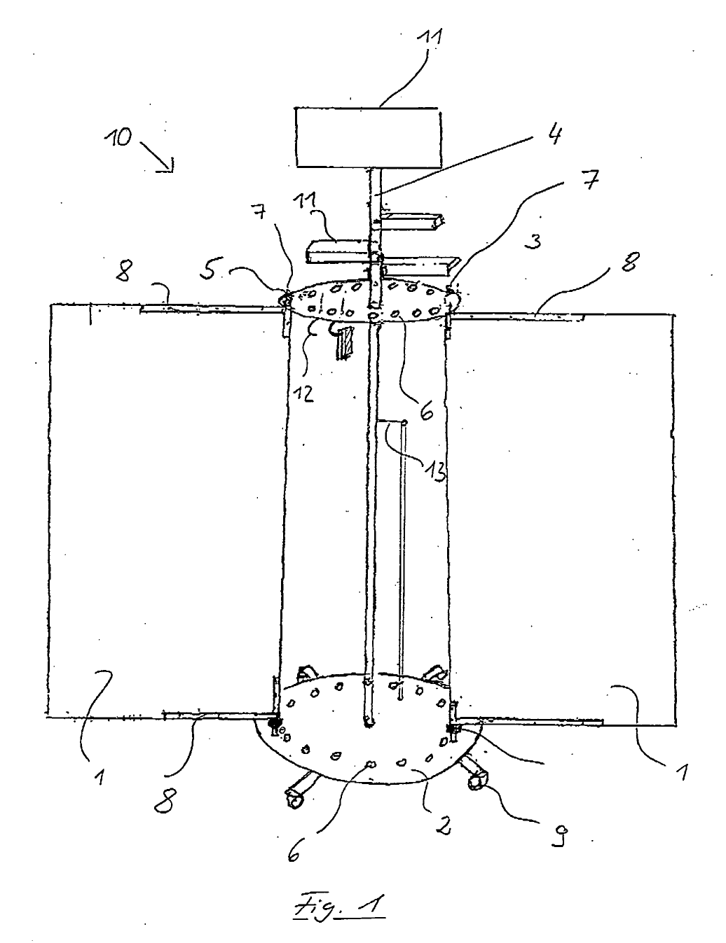

This invention is explained in the following with the aid of a schematic representation of a display unit, as shown in FIG. 1.

The single FIGURE 1 is a schematic showing the construction of a particularly preferred form of embodiment of a display unit in accordance with the invention. The display unit 10 has a bottom carrier plate 2 and top carrier plate 3 that are spaced apart and connected by a carrier 4. Holes 6 are arranged at equal spacing around the circumference of the bottom carrier plate 2. Holes 6 are also provided spaced equally apart on the circumference of the top carrier plate 3. The spacing of the holes 6 in this case is to be arranged so that with the plates 2 and 3 arranged one above the other a panel-shaped material 1 can be arranged essentially vertically between them. The panel-shaped material 1 in this case is held in a mounting 8 that preferably consists of angle iron of U-section, which encloses and holds the upper and lower edges of the panel-shaped material. This U-section angle iron is preferably screwed to the panel-shaped material 1. With a somewhat different form of embodiment, the frame is designed as a U-shaped double-angle iron that encloses and holds the panel-shaped material at two short sides (top and bottom) and on one long edge. With this form of embodiment, the panel-shaped material can be held directly and exclusively by the U-section.

At the corner edges, pegs or pins 7 are provided at the top and bottom that can be engaged with the holes 6. The top pegs 7 are preferably longer than the bottom pegs 7 that engage with the holes 6 of the bottom carrier plate 2. This guarantees that it is easy to assemble the panel-shaped material between the carrier plates 2 and 3, in that the panel-shaped material is first inserted into, or attached to, the corresponding holes 6 in the upper carrier plate 3 by means of the longer pegs and it is locked in place by swinging in to the lower hole 6 in the bottom carrier plate 2. With the form of embodiment shown in the illustration, the carrier 4 is longer than the panel-shaped material 1 arranged as the top edge, thus enabling advertisement supports 11 or similar to be attached above the carrier plate 2. The lower carrier plate 2 is fitted with rollers 9 so that the complete display unit can be moved. The mounting devices 5 that can be swiveled to assist the display, can also have a form of engagement consisting of detent lugs and detent recesses, with the detent lugs being preferably spring loaded in order to facilitate the assembly or replacement of the panel-shaped elements. The bottom pegs 7 are preferably provided with spacers. The intermediate spaces created in this way between the bottom carrier plate 2 and the frame 8 guarantees that the structure can be easily swiveled.

The mobile display unit shown can preferably hold 32 sample panels, one on the back and one on the front of the panel-shaped material in each case. The width of the panels can be up to 80 cm and the height of the panels up to 120 cm. For a given construction of the display unit, these dimensions can be overshot or undershot. Reducing the clearance between the mounting devices can increase the number of samples up to double.

Where 80 cm wide sample panels are used, the display unit requires a space of approximately 2 m in diameter. Narrower sample panels reduce the space requirement considerably. With the display unit shown, the mounting devices 5 of the unit can be simply folded together on two sides thus creating a unit 2 m long and a maximum of 88 cm wide. This narrow width, which can be even reduced to approximately 60 cm by offsetting the rollers, is very important because it enables the complete display unit to be moved outdoors and back again through any shop door. Particularly in fine weather, this can attract the interest of passersby.

With the form of embodiment shown, the bottom carrier plate 2 has a greater diameter than the top carrier plate 3. For example, the bottom carrier plate can have a diameter of 60 cm and the top carrier plate a diameter of 50 cm, thus enabling the fitting of the panel-shaped material 1 between the two carrier plates 2 and 3 to be more easily accomplished. Both carrier plates 2 and 3 have a central hole of approximately 3 cm through which the carrier 4 is passed and/or is welded to the bottom plate 2 in a vertical alignment. Rollers 9 are provided on the bottom carrier plate 2. These can advantageously be swivel-mounted in a conventional manner on a rectangular steel tube. The top and bottom carrier plates 3 and 2 have, as already mentioned, holes 6 of approximately 11 mm in diameter equally spaced around the outer circumference.

The sample panels consist of sheet (plate-shaped material) of the required length, with the height of these sheets being adjusted so that they are 3 cm shorter than the clearance between the bottom carrier plate 2 and top carrier plate 3. Display material (sample of a floor or similar) can be mounted on the front and back of each sheet. This not only increases the number of possible samples that can be displayed but also very substantially reduces the weight of the display unit and reduces the cost.

On the simple form of embodiment shown, an iron or steel pin approximately 8 to 10 mm thick and approximately 4 cm long is welded to the top part of the frame 8. On the bottom part of the frame 8, the length of the pin of the same thickness is only 1 cm. The sample panel 1 is mounted by raising the sample panel (panel-shaped material) and obliquely inserting the top long pin 7 from below into the hole 6 of the top carrier plate 3 and then lowering the panel and inserting the bottom short peg 7 into the hole 6 vertically below it in the bottom carrier plate 2. In the same way, the sample panel 1 can again be temporarily removed from the display unit, for example, to present samples lying flat on the floor. Above the top carrier plate 3, mounting devices for further advertising supports 11 are or can be provided, if the carrier 4, as stated, projects above it. These advertising supports can, for example, be holders for leaflets from which the customer can take written, informative material. Lighting can also be provided here, provided a connection for a power source above the carrier 4 is possible. The carrier 4 is therefore preferably of hollow design, so that the cable can be routed inside it.

Holders 12, for example to hold skirting strips and profile strips are mounted on the underside of the top carrier plate 3. The carrier 4 is also provided with holders 13 to which the floor profiles are fixed.

When used outdoors, the hollow support can also be used to support and secure an effective advertising shade that at the same protects the samples from the weather.

For fixed systems, both carrier plates 2 and 3 can be replaced by angle iron, mounted, spaced at a suitable height, on a wall or column.

The invention should not be limited to the form of embodiment shown. The specialist can, furthermore, find many variations from reading the description, that come within the scope of this invention.

1. Display unit for material (1) that is essentially panel-shaped, consisting of two disk-shaped carrier plates (2,3) that are spaced apart by a vertically aligned carrier (4) and each of which is connected to same, and mounting devices (5) for holding the panel-shaped material (1) between the carrier plates (2,3), characterized in that, the bottom carrier plate (2) has a greater diameter than the top carrier plate (30 and that an equal number of holes (6), aligned vertically relative to each other, are provided in the top and bottom carrier plates (2,3) that, with pegs (7) or similar element that are, or can be, allocated to the particular panel-shaped material (1), can be brought into a reversing and swiveling engagement.

2. Display unit in accordance with claim 1, characterized in that, at least the pegs (7), that interact with holes (6) of the bottom carrier plates (2) are allocated spacers (12).

3. Display unit in accordance with claim 1, characterized in that, the mounting devices (5) in the outer circumference of the carrier plates (2, 3) are spaced equally apart.

4. Display unit in accordance with claim 1, characterized in that, the panel-shaped material (1) can be held in a frame (8).

5. Display unit in accordance with claim 1, characterized in that, for the mounting devices (5) the holes (6) interact with the pegs (7) or similar elements by means of snap-on/clamping or similar connections.

6. Display unit in accordance with claim 1, characterized in that, the carrier (4) is designed as a tube.

7. Display unit in accordance with claim 1, characterized in that, a bottom carrier plate (2) is fitted with rollers (9) for a moveable design of the display stand.

8. Display unit in accordance with claim 1, characterized in that, the carrier (4) is longer than a maximum clearance provided between the carrier plates (2, 3), so that it passes centrally through a top carrier plate (3) and projects beyond same.

9. Display unit in accordance with claim 1, characterized in that, devices (12) or (13) for holding the display objects are provided on the bottom of the top carrier plate (3) and on the carrier (4).

10. Display unit in accordance with claim 1, characterized in that, it is provided with a color code system.

11. Display unit in accordance with claim 1, characterized in that, the essentially panel-shaped material (1) is designed to take display material on both sides.

12. Display unit in accordance with claim 1, characterized in that, the essentially panel-shaped material holds samples of floor coverings of all kinds.
